(19) United States
(12) Patent Application Publication
(10) Pub. No.: US 2005/0054306 A1
(43) Pub. Date: Mar. 10, 2005

(54) Device for wide-band electrical connection of two units mobile relative to each other, with control of the transmitter amplitude

(76) Inventors: Harry Schilling, Eichstatt (DE); Georg Lohr, Eichenau (DE)

Correspondence Address: Conley Rose, P.C., P.O. Box 684908, Austin, TX, 78768-4908, US

(21) Appl. No.: 10/654,634

(22) Filed: Sep. 3, 2003

(30) Foreign Application Priority Data
Sep. 5, 2002 (DE) 10241581.1

(51) Int. Cl. H04B 1/00; H04B 7/00; H04B 1/04; H01Q 11/12

(52) U.S. Cl. 455/127.2; 455/127.1; 455/69

(57) ABSTRACT

What is described here is a device for signal transmission between units mobile along predetermined paths. The device comprises at least one transmitter for generating electrical signals, at least one conductor array for conducting the electrical signals along the path of the movement, as well as at least one receiver for decoupling electrical signals from a conductor array. For an optimization of the signal transmission with a simultaneous reduction of the stray radiation or the interference sensitivity, respectively, the transmitter comprises means for controlling the amplitude of the transmitted signal.

### FIELD OF THE INVENTION

The present invention relates to a device for transmitting electrical signals or energy, respectively, particularly digital signals, between a plurality of units mobile relative to each other.

For the sake of clarity, in the present document, the transmission between units mobile relative to each other, on the one hand, is not distinguished from the transmission between a stationary unit and units mobile relative to the first unit, on the other hand, because this is only a question of local relationship and does not take any influence on the mode of operation of the invention. Equally, a distinction is not made between the transmission of signals and energy because the mechanisms of operation are the same in this respect.

### PRIOR ART

In units mobile along a linear path, such as crane and conveyor installations, and also rotary units such as radar systems and also computer tomographs, it is necessary to transmit electrical signals or energy, respectively, between units mobile relative to each other. To this end, mostly a conductor array is provided in the first unit and corresponding tapping means are provided in the second unit. The term “conductor arrays” as used in the description given below refers to any forms whatsoever of conductor arrays conceivable, which are suitable for conducting electrical signals. This refers also to the known contacting sliding paths or slip rings, respectively.

A suitable device is described in the laid-open German Patent Application DE 44 12 958 A1. There, the signal to be transmitted is supplied into a strip conductor of the first unit that is arranged along the path of the movement of the units mobile relative to each other. The signal is tapped from the second unit by means of capacitive or inductive coupling. The coupling factor of the signal between the two units is substantially a function of the distance of the two units relative to each other. Particularly in transmission systems with three-dimensional extension and particularly in the event of high speeds of movement, the distances between the mobile units cannot be determined with an optional precision, in view of the mechanical tolerances. As a result, as the position of the two units relative to each other, the speed (e.g. caused by vibrations) and other influential parameters vary, the coupling factor frequently varies, too. At the same time, the signal amplitude at the receiver input varies as well. This results in variations in the signal in receivers presenting the conventional structure, which are noticeable, for instance, in the form of an increased jittering or even bit errors.

Another group of problems occurring in such transmission paths relate to the electromagnetic compatibility or noise immunity, respectively. For example, in order to achieve maximum noise immunity it is necessary to select a very high level of the transmitted signal. As a consequence, however, this involves, as a rule, a very high emission of undesirable signals so that the compliance with the applicable EMC regulations is possible only with a high additional expenditure, for example in terms of shielding. When, by contrast, the level of the transmitted signal is selected to be low and in an approach to achieve a lower radiation level the result is a low noise immunity.

The U.S. Pat. No. 6,433,631 B2 discloses a device for feedback control of the input level at the receiver. This solves largely the problem of the varying levels, which is caused by variations of the distances. As a matter of fact, however, this does neither improve the noise immunity nor reduce the emitted radiation.

The U.S. Pat. No. 5,530,422 proposes various measures for improving the noise immunity with a simultaneous reduction of the emitted radiation. In that document, in particular, a line operated on a differential signal is proposed, together with additional shielding provisions. In practical operation, however, it has turned out, in fact, that these measures involve a high expenditure and are very expensive. Moreover, these provisions do not propose a remedy in cases of a varying level of the received signal.

### BRIEF DESCRIPTION OF THE INVENTION

The present invention is based on the problem of designing a device for the transmission of electrical signals, which, based on a conductor array including conductors or conductor arrays, respectively, presents a high quality in transmission and, at the same time, a minimum emission of stray signals.

In accordance with the present invention, the problem is solved with the means defined in the independent Patent Claim. Expedient improvements of the invention are the subject matters of the dependent further Claims.

An inventive device for signal transmission between units mobile along predetermined paths serves preferably to transmit digital signals. It comprises a transmitter (2) for generating electrical signals, a receiver (3) for analyzing electrical signals, and moreover a conductor array (1) for conducting the electrical signals along the path of the movement, as well as a coupler unit (4) for coupling or decoupling electrical signals. For the transmission of the signals from the conductor array to the coupler unit, the transmitter is here connected to the conductor array and furthermore the receiver is connected to the coupler unit. In the event of transmission of electrical signals from the coupler unit to the conductor array, i.e. in the opposite direction, the transmitter is connected to the coupler unit and moreover the receiver is connected to the conductor array. In accordance with the invention, it is, of course, also possible to provide several transmitters or several receivers, respectively, as is described in the German Patent DE 100 21 671 A1. The disclosure of this document constitutes part of the present description of the invention. For a simplified representation, however, reference is only made to a singular transmission between one transmitter and one receiver.

According to the present invention, a controller (5) is provided in the transmitter (2) for controlling the signal amplitude of the transmitter in correspondence with predetermined parameters. On account of such a control of the transmitter, it is possible to match the amplitude of the transmitter optionally with the required electrical requirements of the environment, such as radiation or noise immunity, respectively, and with the receiving conditions, i.e. the distance between the conductor array and the coupler unit so that there is always an optimum connection between the transmitter and the receiver at a minimum of stray radiation. Controlling is optionally possible via mathematical functions or also tables of values. Moreover, controlling means may be optionally provided in such a form that strong variations of the zero point of the signal can be reduced or even completely suppressed, respectively.

In a particularly expedient embodiment of the invention, the conductor array is a slip ring array that is designed, in particular, for the application in computer tomographs. Such a slip ring array may be optionally based on a conventional electrically conductive slip ring, with the signal being tapped optionally via carbon brushes, metal spring wire contacts or other contacting means. It non-conducting tapping from this electrically conductive slip ring is equally possible by means of inductive, capacitive or other field probes. In an alternative, non-contacting transmitter means can be employed, with the conductor array then being based on a conductor line with reflection-free termination. This line may be designed as both a plain line and a line in symmetrical operation.

The inventive array can be realized in a particularly expedient form specifically with slip ring arrays where the path of the movement corresponds to a circular path because in such a case the movements between the transmitter and the receiver are periodically repeated as the revolution continues. Hence, the demands on the signal amplitude of the transmitter are also periodically repeated.

In another expedient embodiment of the invention, the controller (5) comprises a device for forming an average value. By means of this device, the signal amplitude of the transmitter can be controlled in such a way that a predetermined average value of the amplitude will not be exceeded. This averaging is expediently carried out over a predetermined time interval. Moreover, this time interval is expediently adapted to the usual measuring methods of measuring the EMC characteristics or stray radiation, respectively. For measurements in compliance with CISPR 11, this interval expediently corresponds to 100 ms, for instance, and is hence also in correspondence with the integration interval of this measuring technique. Such averaging technique permits a short-term increase of the level of the transmitter when high external noise levels are present or other aggravated conditions prevail in transmission, such as a wide distance between the coupler unit ands the conductor array, without a resulting non-compliance with the applicable standard.

Another embodiment of the invention proposes the provision of a device in the receiver (3) for measuring the amplitude of the received signal. This device communicates a detected magnitude of the signal amplitude to the controller (5) of the transmitter (2). Moreover, the controller of the transmitter comprises means for feedback control of the signal amplitude of the transmitter, with this amplitude being controlled in such a way that the amplitude of the received signal is maintained at a constant level. Signaling can be carried out, for instance, on a separate slip ring repeater, via a further wireless (radio) connection or even by means of the same conductor array in a different frequency range. This feedback is comparatively non-critical and not sensitive to interference because it takes place within a narrow band. For instance, the signal amplitude varies only at the comparatively low frequency of the movement of the units relative to each other.

Another embodiment of the invention proposes the provision of a device for measuring the signal-to-noise ratio or another parameter representative of the quality of the signal in the receiver (3). This device communicates a corresponding detected parameter to the controller (5) of the transmitter (2). Moreover, the controller of the transmitter comprises means for feedback control of the signal amplitude of the transmitter, with the amplitude being controlled in such a way that the signal-to-noise ratio or another parameter representative of the quality of the signal is maintained at a constant level. Signaling may here take place, too, in the aforedescribed manner.

According to a further embodiment of the invention, a device is provided in the receiver (3) for measuring the bit error ratio. This device communicates a corresponding detected parameter to the controller (5) of the transmitter (2).

The controller of the transmitter comprises furthermore means for feedback control of the signal amplitude of the transmitter, with this amplitude being controlled in such a way that the bit error ratio is maintained at a constant level. Here, too, signaling can be performed in the aforedescribed manner.

A further embodiment of the invention proposes the provision of a display device that signals the averaged signal amplitude of the transmitter (2) as a measure of the quality of the transmission path. This signaling may optionally be performed by an analog or digital display, an indication in the form of binary values for communication to an analyzer or a computer, or an optical or acoustical indication. What is preferred here is a multi-color display in the form of a traffic light signaling the conditions “acceptable”, “critical” and “non-acceptable”.

In another expedient embodiment, the controller (5) comprises at least one additional output for release of an increased or the maximum signal amplitude, respectively, of the transmitter (2). Hence, an influence may be taken on the signal amplitude by external signals. When, for instance, a field strength detector is provided that detects unwanted external signals this detector is capable of increasing the amplitude of the transmitter either in steps or in proportion to the interference, by means of an output signal, in order to ensure a homogeneous quality in transmission. It is equally possible that optional devices or components, respectively, which are integrated into a system, emit a signal for increasing the amplitude of the transmitter. For example, in the case of application in computer tomographs, such a signal may be output in parallel with the control of the radiation performance of the X-ray tube. It is optionally possible to provide additional means for appropriate adaptation of the receiver (sensitivity, hysteresis).

A particularly expedient embodiment of the external provisions for controlling the radiation performance is achieved in combination with the synchronization of low-frequency-disturbing elements. In complex equipment such as a computer tomograph, a plurality of low-frequency-disturbing elements is provided. The term “low-frequency” here denotes signal frequencies that a noticeably lower—which means, preferably by one order—than the minimum frequency of the signal transmission between the transmitter and the receiver. When, for example, a typical signal transmission with a clock rate of 1 GHz is applied at a word length of 10 bits this furnishes a lower limit frequency of the signal of 100 MHz. Hence, interference at a frequency lower than 10 MHz is to be understood as low frequency in the meaning of the present description. In a computer tomograph, a typical high-performance low-frequency-disturbing element is the high-voltage supply of the X-ray tube. It comprises frequently a fixed-cycle power supply unit that is operated at a clock frequency of 20 to 100 kHz. In accordance with the invention, the power emitted by the transmitter is synchronized with the clock frequency of such a power supply unit in such a case. It is hence possible that within the time intervals during which particularly high interference levels occur the power emitted by the transmitter can be increased in an appropriate manner. Synchronization can be performed, for instance, by means of a signaling line or an optical connection from the disturbing element to the controller (5). It is equally possible to provide also a plain antenna for synchronization that receives the electromagnetic radiation from the disturbing element.

In another embodiment of the invention, the controller (5) in the transmitter (2) comprises means for detecting the distance between the transmitter (2) and the receiver (3). The signal amplitude of the transmitter is now controlled in correspondence with this distance. It is commonly known that the signal amplitude may vary along the path of movement as a result of manufacturing tolerances and other variations. The distance between the transmitter and the receiver takes a direct influence on signal transmission. For example, a reduced signal is transmitted at a wider distance, and vice versa. The term “distance” denotes here the distance in the direction of transmission of the signal between the transmitter and the receiver. This will mostly be the shortest distance between the transmitter and the receiver. It is composed of a component in the X-direction and the Z-direction. The X-component will mostly be predominant. In simple cases, it is therefore sufficient to determine the distance in the X-direction. If, however, the distance or the variations of the distance will be more important in the Z-direction in the Z-direction they must also be considered. When the demands on precision are higher or when major variations are present in the Z-direction the distance may be determined by detecting the vector amount from X and Z. When the conductor array or the coupler unit displays a certain directional effect this effect can be considered as well. When the distance between the transmitter and the receiver is determined it is possible to derive the attenuation of the transmission and hence also the required transmitting power for a predetermined quality in transmission from this distance, expediently by means of predetermined functions or stored invariable values.

In a further expedient embodiment of the invention, the controller (5) is designed for controlling the amplitude of the transmitter (2) in response to the position in the Y-direction. Such a control concept makes sense, in particular, when precise information is available in relation to the position in the Y-direction, like in a computer tomograph, for instance. In this manner it is possible to conclude the distance in the X-direction and in the Z-direction from this information when the geometry of the conductor array or the path of the movement between the transmitter and the receiver is known. For example, this distance can be precisely measured once by the time of start-up of the equipment. The consideration of the position in the Y-direction makes also sense when, for instance, a radiation of the conductor array is dependent on the position and therefore the transmitted power must be reduced in certain ranges or regions.

### DESCRIPTION OF THE DRAWINGS

In the following, the present invention will be described by exemplary embodiments, without any limitation of the general inventive idea, with reference to the drawings.

FIG. 1 shows a schematic illustration of an inventive device in a general form.

FIG. 2 illustrates typical forms or graphs of a particularly expedient embodiment of the invention.

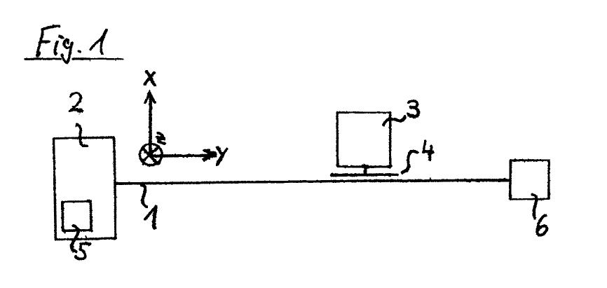

FIG. 1 illustrates an example of an inventive device. For instance, a first unit comprises here a transmitter (2) for generating electrical signals, in combination with a conductor array (1) for conducting electrical signals, which array is terminated in a reflection-free manner by a terminating element (6) on the end opposite to the transmitter. A second unit is arranged for movement opposite to this first unit. This second unit comprises a coupler unit (4) for decoupling electrical signals from the conductor array as well as a receiver (3) for analyzing the signals decoupled by means of the coupler unit. In this case, the direction of signal flow extends from the conductor array to the coupler unit. In correspondence with the inventive idea, the opposite direction of signal flow is encompassed as well. The transmitter (2) comprises moreover a controller (5) for controlling the signal amplitude of the transmitter in correspondence with predetermined parameters.

The coordinate arrows define a right-handed coordinate system to which reference is made in the description. For instance, the movement is carried out between the two units in the direction of the Y-axis. When the conductor array or the path of the movement, respectively, presents a circular design the Y-axis is meant here to denote the tangent at that site on the conductor array where a perpendicular from the geometric center of the coupler on the conductor array intersects with the latter.

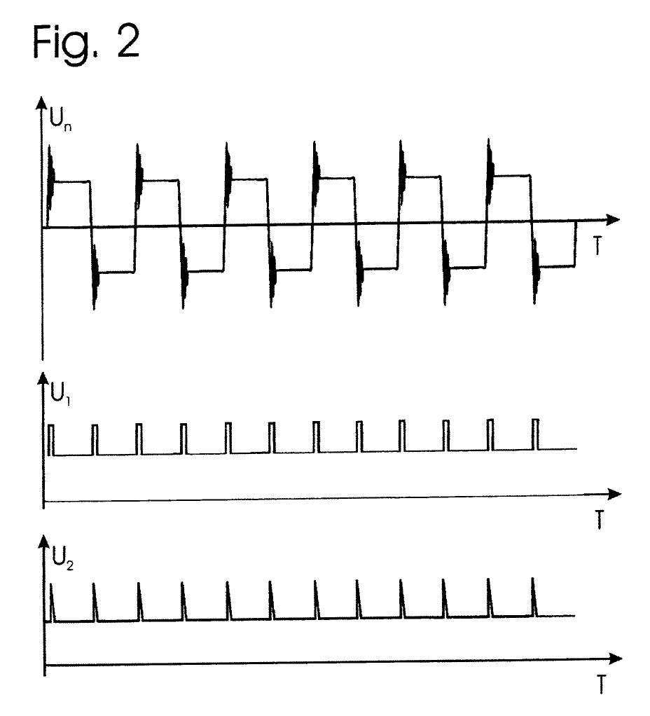

FIG. 2 illustrates the graphs of electrical characteristics of a particularly expedient embodiment of the invention. All three graphs are plotted on the horizontal as a function of the time and along the vertical as a function of a voltage or amplitude, respectively. The graph identified by Un illustrates the progression of voltage on the final stage of a typical fixed-cycle switching power supply unit of the kind used, for instance, for the high-voltage supply of X-ray tubes in computer tomographs. Such voltage characteristics occur in many high-performance circuits in electronics, particularly in numerous fixed-cycle power supply unit circuits. High-frequency high-amplitude oscillations occur at the end—and in some types of equipment also at the beginning—of each switching edge. These oscillations may interfere with the signal transmission between the transmitter and the receiver. In accordance with the invention, the signal amplitude of the transmitter is therefore matched in an appropriate manner. The graph identified by U1 reflects the signal amplitude of the transmitter in a particularly simple case where, during the time of the high-frequency oscillations in the switching signal of the power supply unit, the amplitude of the transmitted signal is raised. This increase of the amplitude is so dimensioned that even when the high-frequency oscillations are present a perfect transmission is possible between the transmitter and the receiver. The graph identified by U2 illustrates another embodiment where the amplitude of the transmitted signal is raised in correspondence with the amplitude of the high-frequency oscillations. For instance, in the case of a high amplitude of the high-frequency oscillations, a high amplitude of the transmitted signal is envisaged that decreases, as the high-frequency oscillations decay, equally down to a minimum value. This minimum value is so dimensioned that in the case of a non-existing high-frequency oscillation a reliable transmission is still possible. Due to this design, the mean high-frequency energy emitted by the conductor array can be substantially reduced. At a constant amplitude of the transmitted signal, this energy ought to be provided at a maximum value that ensures a reliable transmission even when the high-frequency oscillations are present. Due to the synchronization it is now possible to reduce the transmitted power without a substantial influence on the quality in transmission in the quiescent periods in switching of the switching power supply unit. As a result, the emitted mean high-frequency energy is reduced as well. Moreover, this results in a reduction of the thermal load on the transmitter that may thus be dimensioned in a corresponding smaller form. According to the invention, it is necessary, of course, to combine this synchronization of the amplitude of the transmitted signal also with a further control or feedback control of the amplitude of the transmitted signal, for instance in correspondence with the distance between the conductor array and the coupler unit.

### LIST OF REFERENCE NUMERALS

1 conductor array
2 transmitter
3 receiver
4 coupler unit
5 controller
6 terminating element

1. Device for signal transmission, preferably for the transmission of digital signals, between units mobile along predetermined paths, comprising
a transmitter (2) for generating electrical signals,
a conductor array (1) for conducting the electrical signals along the path of the movement of a coupler unit (4) for coupling or decoupling electrical signals into and from said conductor array, and
a receiver (3) for analyzing electrical signals,
wherein optionally for the transmission of signals from said conductor array to said coupler unit, said transmitter is connected to said conductor array and said receiver is connected to said coupler unit, or for the transmission of signals from said coupler unit to said conductor array said transmitter is connected to said coupler unit and said receiver is connected to said conductor array, characterized in that a controller (5) is provided in said transmitter (2) for controlling the amplitude of signals of said transmitter in correspondence with predetermined parameters.

2. Device according to claim 1, characterized in that said conductor array is a slip-ring array, in particular for the application in computer tomographs.

3. Device according to claim 1 or 2, characterized in that said controller (5) comprises a device for forming the average value for controlling the signal amplitude of said transmitter, by means of which the signal amplitude of said transmitter is controllable in such a way that a predetermined mean amplitude value, averaged over a predetermined time interval, will not be exceeded.

4. Device according to any of the preceding claims, characterized in that a device is provided in said receiver (3) for measuring the amplitude of the received signal, which communicates a detected magnitude of the signal amplitude to said controller (5) of said transmitter (2) and that said controller of said transmitter comprises means for feedback control of the amplitude of the transmitted signal in such a way that the amplitude of the received signal is maintained at a constant level.

5. Device according to claim 1, characterized in that a device is provided in said receiver (3) for measuring the signal-to-noise ratio, which communicates a detected magnitude of the signal amplitude to said controller (5) of said transmitter (2), and that said controller of said transmitter comprises means for feedback control of the transmitter amplitude in such a way that the signal-to-noise ratio is maintained at a constant level.

6. Device according to claim 1, characterized in that a device is provided in said receiver (3) for measuring the bit error ratio, which communicates a detected magnitude of the signal amplitude to said controller (5) of said transmitter (2) and that said controller of said transmitter comprises means for feedback control of the transmitter amplitude in such a way that the bit error ratio is maintained at a constant level.

7. Device according to any of the preceding claims, characterized in that a signaling means is provided for signaling the averaged signal amplitude of said transmitter (2) as a measure of the quality of the transmission path.

8. Device according to any of the preceding claims, characterized in that said controller (5) comprises at least one additional input for release of an increased or the maximum signal amplitude of said transmitter (2).

9. Device according to claim 8, characterized in that additional means are provided for signaling defined operating states of at least one unit emitting stray signals, whose stray signals cause an influence on the device for signal transmission, which additional means are connected to an additional input for release of an increased or the maximum signal amplitude of said transmitter (2) in such a way that during the time intervals of transmission of increased stray signals the signal amplitude of said transmitter is increased correspondingly.

10. Device according to any of the preceding claims, characterized in that said controller (5) comprises means for detecting the distance between said transmitter (2) and said receiver (3) and controls the signal amplitude of said transmitter in correspondence with this distance. 11. Device according to any of the preceding claims, characterized in that said controller (5) comprises means for detecting the position of said transmitter (2) and said receiver (3) on the path of the movement and controls the signal amplitude of said transmitter in correspondence with this position.
